(19) United States
(12) Patent Application Publication
(10) Pub. No.: US 2013/0280044 A1
(43) Pub. Date: Oct. 24, 2013

(54) CORROSION MONITORING DEVICE

(71) Applicants: Abhijeet Madhukar Kulkarni, Basingstoke (GB); William Keith Albert Eyers, Chobham (GB); Richard Michael Ashley Mann, Basingstoke (GB); Mark David Richardson, Farnham (GB)

(72) Inventors: Abhijeet Madhukar Kulkarni, Basingstoke (GB); William Keith Albert Eyers, Chobham (GB); Richard Michael Ashley Mann, Basingstoke (GB); Mark David Richardson, Farnham (GB)

(73) Assignee: General Electric Company, Schenectady, NY (US)

(21) Appl. No.: 13/452,294

(22) Filed: Apr. 20, 2012

(51) Int. Cl. F04D 29/00; G01N 17/00

(52) U.S. Cl. 415/118; 422/53

(57) ABSTRACT

This disclosure describes, in one embodiment, a corrosion monitoring device to monitor fluid flowing to a turbo-machine. The device comprises an elongated body member in the form of a threaded rod. The elongated body member comprises test elements that have material properties responsive to the corrosive components. In one example, the test elements comprise cylindrical tubes that can slide onto the threaded rod. The assembly is positioned in flow streams and, more particularly, finds particular use in the flow stream of fluid found in an inlet system that couples with a turbine (e.g., a gas or steam turbine).

### BACKGROUND OF THE INVENTION

The subject matter disclosed herein relates to fluid (e.g., air) quality monitoring and, in particular, to embodiments of a device for monitoring corrosive contaminants in fluid that enters a turbo-machine.

Gas turbines, aero-derivatives, and other varieties of turbo-machinery use a fluid inlet system that channels incoming fluid towards a compressor. The inlet system can have a filter section to screen the fluid of foreign objects and other materials. Typically, the inlet system and the compressor comprise metals that may corrode when exposed to certain contaminants, which come from the environment in which the turbo-machine operates.

Some turbo-machines may develop microenvironments, e.g., areas of the turbo-machine in which the fluid flows with different flow properties (e.g., velocity and pressure). These flow properties can increase the rate of corrosion. Moreover, the differences in the flow properties across the turbo-machine prevents the use of ambient conditions to identify the rate of corrosion that will occur throughout the various parts, areas, and microenvironments. Rather, it is likely that techniques to determine the environmental effects of the fluid on the turbo-machine, e.g., on the compressor components, may necessarily monitor fluid downstream of the turbo-machine.

One technique to measure the rate of corrosion is to place strips (hereinafter “coupons”) in the stream of fluid. This configuration exposes the coupons to the fluid, which may cause the coupons to corrode and fail. An end user (e.g., a technician) can monitor the progress of corrosion and time to failure through, for example, periodic visual examination of coupons. For more accurate determinations, however, the coupons are sent to a lab for more time consuming and expensive testing to determine the type(s) of corrosives that caused the failure.

Use of coupons can cause a few problems. For example, all or part of the coupons may upon failure dislodge and become a projectile that can potentially cause damage to the compressor components. The coupons may also create flow distortion waves that can also damage turbo-machine components.

The discussion above is merely provided for general background information and is not intended to be used as an aid in determining the scope of the claimed subject matter.

### BRIEF DESCRIPTION OF THE INVENTION

This disclosure describes embodiments of a device for monitoring corrosive components suspended in fluid flowing to a turbo-machine. The device comprises an elongated body member with test elements that have material properties responsive to the corrosive components. In one example, the test elements comprise cylindrical tubes that can slide onto the threaded rod. The assembly is positioned in flow streams and, more particularly, finds particular use in the flow stream of fluid found in an inlet system that couples with a turbine (e.g., a gas or steam turbine). An advantage that the practice of some embodiments of the device is to provide a robust device to identify the presence and/or absence of constituent components in the fluid, without having a detrimental or adverse affect on the flow stream of fluid flowing to the turbo-machine.

The disclosure describes, in one embodiment, a corrosion monitoring device. The corrosion monitoring device comprises an elongated body member having a central axis and a test element disposed on the elongated member. The test element comprising a material with properties that corrode in the presence of contaminants in a fluid.

The disclosure also describes, in one embodiment, a corrosion monitoring device that comprises a threaded rod having a central axis. The corrosion monitoring device also comprises a test element in surrounding relation to the threaded rod. The test element comprises a first test element, a second test element, and a spacer assembly disposed therebetween. The first test element and the second test element having properties that corrode in the presence of contaminants in the fluid.

The disclosure further describes, in one embodiment, a system for generating power. The system comprises a turbo-machine and an inlet system coupled to the turbo-machine. The inlet system directs fluid from the surrounding environment to the turbo-machine. The system also comprises a corrosion monitoring device coupled to a wall of the inlet system. The corrosion monitoring device comprises an elongated body member and a test element in surrounding relation to the elongated body member. In one example, the test element projects into the inlet system to expose the test element to the fluid flowing therein.

This brief description of the invention is intended only to provide a brief overview of the subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts an exemplary corrosion monitoring device;

FIG. 2 illustrates one implementation of the corrosion monitoring device of FIG. 1 in an inlet system to a turbo-machine;

FIG. 3 depicts a front view of the inlet system of FIG. 2;

FIG. 4 depicts another exemplary corrosion monitoring device; and

FIG. 5 depicts details of the corrosion monitoring device of FIG. 4.

### DETAILED DESCRIPTION OF THE INVENTION

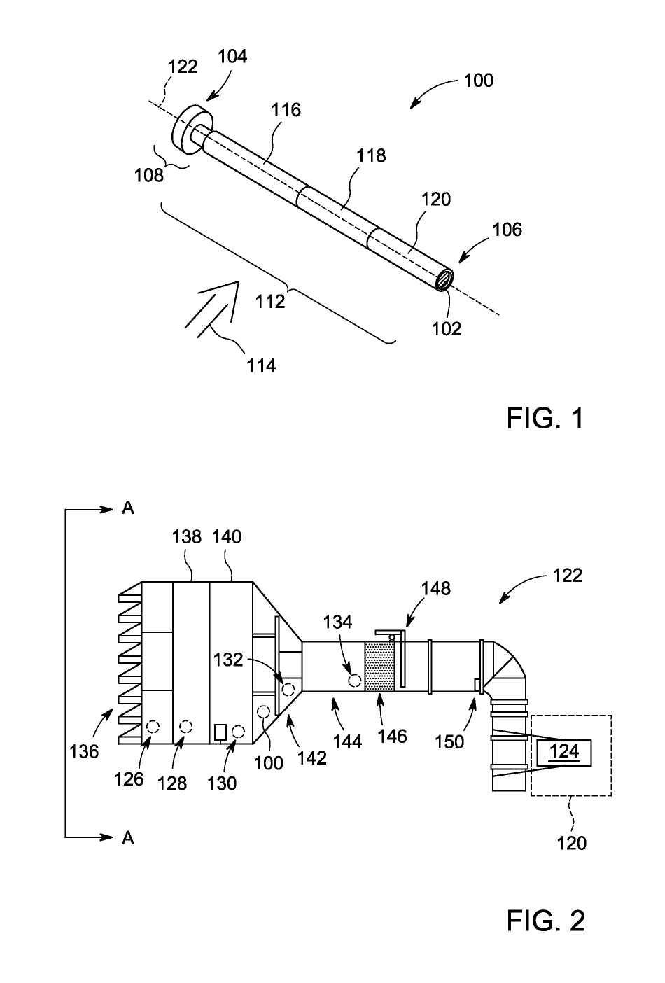

FIG. 1 illustrates an exemplary corrosion monitoring device 100 (also “device 100”) that is useful to detect corrosive contaminants in a fluid. The device 100 includes an elongated body member 102 with a first end 104 and a second end 106. At the first end 104, the device 100 includes a mounting element 108, which can secure the device 100 to a wall or other structure. The elongated body member 102 has a test element 112 that indicates the presence of corrosive contaminants, e.g., materials found in a fluid 114 that contacts the surface of the test element 112. In one example, the test element 112 includes a first test element 116, a second test element 118, a third test element 120 that extend along a central axis 122. The test elements 116, 118, 120 can comprise materials with properties that may react to certain contaminants present in the fluid 114. The type of material can be pre-selected, e.g., in connection with an industry standard or other factors that define the type of contaminants present or known to be present in the fluid 114. In one embodiment, the test elements 116, 118, 120 comprise different materials to make the device 100 sensitive to several different types of contaminants in the fluid 114.

The elongated body member 102 can form a unitary and/or monolithic structure which integrates the test elements 116, 118, 120 therein. The mounting element 108 can attach to this structure, thereby providing one way to mount the elongated body member 102 to any corresponding feature. In one alternative, the test elements 116, 118, 120 embody separate pieces that mount adjacent to one another. These separate pieces can secure to one another, e.g., using threaded connectors, fasteners, and/or features on the test elements 116, 118, 120 to secure the first test element 116 to the second test element 118 and the second test element 118 to the third test element 120. As discussed more below, the elongated body member 102 in other examples of the device 100 may include a secondary piece that supports the test element 116, 118, 120 thereon.

Designs that form the test elements 116, 118, 120 as separate pieces afford the device 100 with some level of flexibility to address different types of contaminants. For example, the separate pieces can be removably replaceable from the device 100. This construction permits the device 100 to be configured and re-configured with different materials and/or reactive properties. In one implementation, a technician can remove the device 100 from its position in a flow stream, examine the test elements 116, 118, 120, and determine whether to replace one or more of the test elements 116, 118, 120 as desired. The separate pieces are likewise amenable for transport (separate from, e.g., the secondary piece and/or other parts of the device 100) to a remote location (e.g., a lab) for more detailed testing and analysis. To continue monitoring and testing, however, the technician can position new pieces that embody the test elements 116, 118, 120 as part of the device 100 and, ultimately, re-install the device 100 into the flow stream.

As shown in FIG. 1, the surface of the elongated body member 102 forms a profile with a curvilinear shape. This feature reduces the effect the corrosion monitoring device 100 may have on the flow stream. For example, it is desirable that the elongated body member 102 does not cause undue pressure drop or induce other changes in the flow stream when the corrosion monitoring device 100 is positioned in a turbo-machine system. Examples of the profile can form the generally cylindrical shape shown in FIG. 1 or, in other embodiments, the profile can have other shapes, e.g., an airfoil shape, that reduce drag of the elongated body member 102 on the fluid 114.

The mounting element 108 can support the elongated body member 102 in a cantilevered configuration, with the first end 104 secured proximate a structure and the second end 106 left relatively unsupported. This configuration exposes of the test elements 116, 118, 120 to the fluid 114. Examples of the mounting element 108 can include nuts and threaded fasteners that engage a similarly threaded portion of the elongated body member 102 at the first end 104. Selected fasteners (and threads) and components of the mounting element 108 should secure the device 100 in a manner to withstand vibration and other mechanical motion that might be present at the location of the mounting location. This motion may occur as a result of operation of an asset (e.g., a turbo-machine) as well as or in addition to motion the flow stream induces as the fluid 114 contacts the elongated body member 102. In one implementation, the mounting element 108 also permits an end user (e.g., a technician) to rapidly mount and dismount the device 100 from the structure. This feature permits timely inspection of the test elements 116, 118, 120 to determine, in one example, whether the fluid 114 causes corrosion to form on the test element 112. Such corrosion, when considered in combination with the properties (e.g., material properties) of the test element 116, 118, 120, can help to identify the types, levels, and other characteristics of contaminants in the fluid 114.

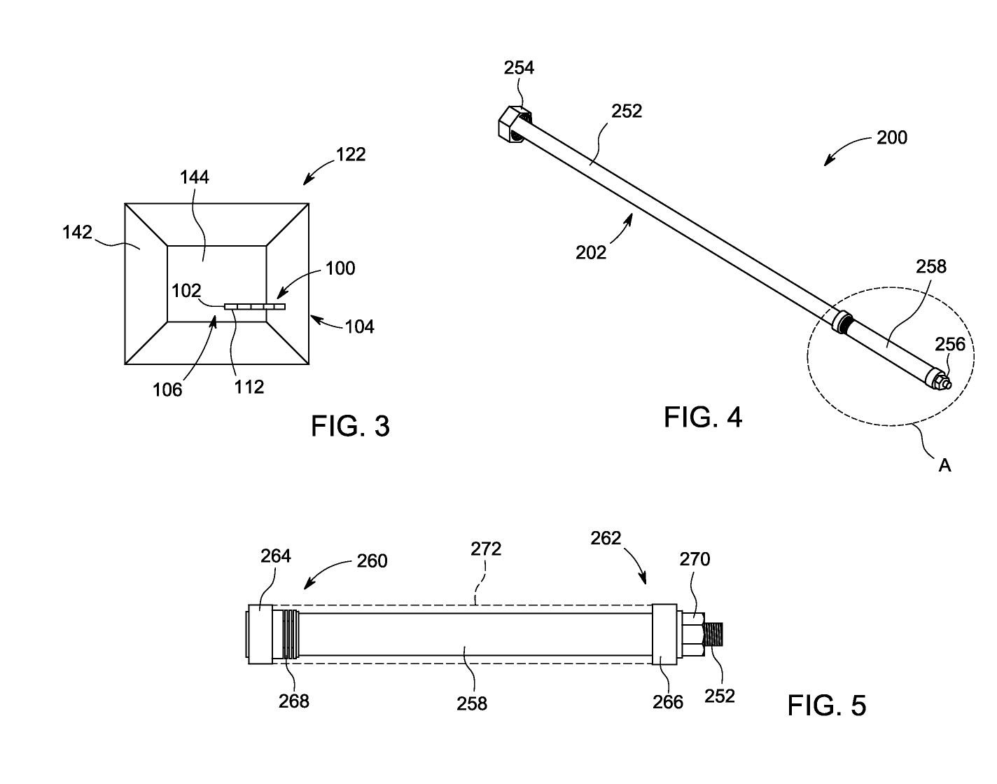

FIGS. 2 and 3 depict one implementation of the contaminant monitoring device 100 to detect and/or monitor constituent components (e.g., debris, moisture droplets, etc.) found in fluid traveling to a turbo-machine 123. FIG. 2 shows a side view of the turbo-machine 123 and an inlet system 124, which together form a turbo-machine system that comprises structure to ensure an appropriate supply of fluid to the turbo-machine 123. In one example, the device 100 mounts to a wall of the inlet system 124. FIG. 3 shows a front view of the inlet system 124 taken at line A-A of FIG. 2. This view illustrates the cantilevered configuration of the device 100 when in position in the inlet system 123.

As shown in FIG. 2, a compressor 125 couples with the inlet system 124 to move fluid through the inlet system 124 and into the turbo-machine 123. The device 100 couples with the structure of the inlet system 124 to expose the test element 112 to the moving fluid. Depending on the level of detection required and other design requirements, the inlet system 124 can accommodate one or more of the devices 100 at various mounting or sampling locations (e.g., a first location 126, a second location 128, a third location 130, a fourth location 132, and a fifth location 134).

The device 100 can help to reduce damage to the turbo-machine 123 by monitoring contaminants found in fluid flowing through the inlet system 124. These contaminants can damage parts of the turbo-machine 123, e.g., fan blades that rotate in the path of the fluid during operation. The present design provides a low cost technique to monitor and to identify the types of contaminants and concentration levels that are present in the fluid and the environment in which the turbo-machine 123 is found. Moreover, the device 100 can insert directly into the flow stream that forms in the interior of the inlet system 124, permitting a more accurate measure of contaminants (as compared to devices that draw off a sample of fluid to a remote measuring station) without unduly obstructing the flow stream to the turbo-machine 123.

Continuing with the discussion of the inlet system 124, and moving from left to right in the diagram of FIG. 2, in one example, the inlet system 124 includes a weather hood 136 and an inlet filter housing 138. A cooling module 140 may be found inside of the inlet filter housing 138. The cooling module 140 may include a washing system that disperses fluid (e.g., water) into the inlet filter housing 138 to facilitate filtering of the fluid flowing therethrough. A transition piece 142 couples the inlet filter housing 138 to an inlet duct 144. The physical characteristics of these elements help to develop certain flow characteristics (e.g., velocity, pressure, etc.) in the flow of fluid as the fluid transits the inlet system 124 to the turbo-machine 123. Inside of inlet duct 144, the fluid can encounter one or more other elements, e.g., a silencer section 146, heating system 148, and screen element 150, which are useful for conditioning the fluid as the fluid travels through the inlet system 124 to the turbo-machine 122.

As best shown in FIG. 3, the device 100 can extend through the wall (e.g., a wall of the transition piece 142) and into the path of fluid in the inlet system 124. In one implementation, a technician can secure the device 100 in place on the wall and/or at one or more of the designated location(s) of the inlet system 124. To simplify installation, these locations can comprise an opening, aperture, and/or other feature to provide access into the interior of the inlet system 124 from outside of the inlet system 124. In one example, the technician can insert the second end 106 of the elongated body member 102 through the opening. The mounting element (e.g., mounting element 108 of FIG. 1) on the first end 104 is secured to position the device 100 and to maintain the cantilevered configuration (as shown in FIG. 3).

FIG. 4 illustrates another exemplary contaminant monitoring device 200 (also “device 200”) that can detect contaminants in fluid. These contaminants may cause corrosion and/or degradation to appear on the device 200. In one embodiment, the device 200 has an elongated body member 202 with a threaded rod 252, which can comprise threads that extend along its length or, in one example, along a portion at each of the ends. Threaded fasteners (e.g., a first threaded fastener 254 and a second threaded fastener 256) are found on either end of the threaded rod 252.

The device 200 also includes a test coupon 258, e.g., a cylinder or tube with a hollow center that fits about the threaded rod 252. The cylinder can comprise materials that react to contaminants present in fluid. Exemplary materials include carbon steels, alloy steels, copper, aluminum, zinc, other alloys, and the like. In one embodiment, the test coupon 258 slides onto the threaded rod 252. This feature allows the test coupon 258 to traverse the length of the threaded rod 252, which in turn permits the test coupon 258 to assume a variety of positions on the threaded rod 252. Although only one test coupon 258 is shown, this disclosure contemplates configurations of the device 200 with a plurality of the test coupons 258 in position on the threaded rod 252. A configuration with multiple test coupons 258 mimics the arrangement of test elements 116, 118, 120 discussed in connection with FIG. 1 above.

The threaded rod 252 provides support for the test coupon 258. Examples of the threaded rod 252 can embody elongated cylindrical shapes, as shown in FIG. 4, as well as other any variety of shapes (e.g., round, square, and rectangular bar stock). Selection of the shape and/or construction may depend on the particular application, which may dictate specific design requirements (e.g., strength, length, etc.) for the threaded rod 252. Exemplary materials for use in the threaded rod 252 include metals (e.g., steels, aluminums) and/or other high-strength materials with rigidity sufficient to withstand the velocity of fluid and other fluids, e.g., velocity typical of the turbo-machine system discussed above. Materials may also be selected that are inert, or otherwise chemically inactive, with the material(s) of the test coupons 258 to avoid inadvertent contamination that can cause premature corrosion and/or reaction in the test coupons 258 contaminants in the fluid do not induce.

FIG. 5 shows details of the device 200 as indicated by Detail A of FIG. 4. In one example, spacer assemblies (e.g., a first spacer assembly 260 and a second spacer assembly 262) bound either side of the test coupon 258. The spacer assemblies 260, 262 can include a spacer (e.g., a first spacer 264 and a second spacer 266) and/or one or more washers 268. A threaded nut 270 couples with end of the threaded rod 252 to retain all of the components thereon. In one example, the device 200 can also have a protective sleeve 272, which bounds at least a portion of the test coupon 258. Examples of the protective sleeve 272 prevent material and debris that may shed from the test coupon 258 from traveling downstream to the turbo-machine. The protective sleeve 272 may comprise mesh screen or other semi-porous material, which has properties that are suitable to capture the debris but not to restrict the passage of fluid over and, in one example, in contact with the surface of the test coupon 258.

Collectively, the assembly shown in the example of FIGS. 4 and 5 secures the test coupons 258, and other components, onto the threaded rod 252. This configuration prevents the test coupon 258 from becoming dislodged from the device 200. The spacer assemblies 260, 262 separate the test coupon 258 from other test coupons (not shown) that reside adjacent the test coupon 258 on the device 200. This configuration prevents cross-contamination between the test coupons and ensure accurate test results. Contamination can occur, for example, when coupons of different materials are in contact with one another. Examples of the spacers 264, 266 can comprise polymer gaskets as well as other inert materials (e.g., plastics and composites). Like the spacers 264, 266, the washers 268 can comprise polyamide and similar materials.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A corrosion monitoring device, comprising:
an elongated body member having a central axis; and
a test element disposed on the elongated member, the test element comprising a material with properties that corrode in the presence of contaminants in a fluid.

2. The corrosion monitoring device of claim 1, wherein the test element comprises a first test element and a second test element that comprise materials that corrode in the presence of different contaminants.

3. The corrosion monitoring device of claim 2, wherein the first test element and the second test element comprise cylindrical tubes.

4. The corrosion monitoring device of claim 1, wherein the elongated body has a threaded portion on one end to receive a nut.

5. The corrosion monitoring device of claim 1, wherein the test element forms a monolithic structure that extends along the central axis of the elongated body member.

6. The corrosion monitoring device of claim 1, wherein the test element comprises separate pieces that mount adjacent to one another along the reactive portion.

7. The corrosion monitoring device of claim 6, wherein the separate pieces are spaced apart from one another with material inert to the material of the separate pieces.

8. The corrosion monitoring device of claim 1, wherein the test element is removably replaceable from the elongated body member.

9. The corrosion monitoring device of claim 1, wherein the elongated body member forms a profile with a curvilinear shape.

10. The corrosion monitoring device of claim 1, further comprising a protective sleeve disposed in surrounding relation to the test element, the protective sleeve comprising porous material.

11. A corrosion monitoring device, comprising:
a threaded rod having a central axis; and
a test element in surrounding relation to the threaded rod, the test element comprising a first test element, a second test element, and a spacer assembly disposed therebetween, the first test element and the second test element having properties that corrode in the presence of contaminants in the fluid.

12. The corrosion monitoring device of claim 11, further comprising a threaded fastener disposed at a first end of the threaded rod.

13. The corrosion monitoring device of claim 11, wherein the first test element and the second test element comprise a tube.

14. The corrosion monitoring device of claim 11, wherein the spacer assembly comprises material that is different from the first test element and the second test element.

15. The corrosion monitoring device of claim 11, wherein the spacer assembly comprises a spacer and one or more washers.

16. A system for generating power, comprising:
a turbo-machine;
an inlet system coupled to the turbo-machine, the inlet system directing fluid from the surrounding environment to the turbo-machine;
a corrosion monitoring device coupled to a wall of the inlet system, the corrosion monitoring device comprising an elongated body member and a test element in surrounding relation to the elongated body member, wherein the test element projects into the inlet system to expose the test element to the fluid flowing therein.

17. The system of claim 16, wherein the test element comprises material that corrodes in the presence of contaminants in the fluid.

18. The system of claim 16, wherein the corrosion monitoring device comprises a threaded fastener that couples with the elongated body member to support the elongated body member in a cantilevered configuration from the wall.

19. The system of claim 16, wherein the inlet system can accommodate more than one of the corrosion monitoring device.

20. The system of claim 16, wherein the corrosion monitoring device mounts downstream of the turbo-machine.
